(19) United States
(12) Patent Application Publication
(10) Pub. No.: US 2026/0080512 A1
(43) Pub. Date: Mar. 19, 2026

(54) METHOD FOR PROCESSING IMAGE DATA FOR THE APPLICATION OF A MACHINE LEARNING MODEL

(71) Applicant: Robert Bosch GmbH, Stuttgart (DE)

(72) Inventors: Tamas Kapelner, Hildesheim (DE); Matthias Kirschner, Hildesheim (DE)

(21) Appl. No.: 19/110,727

(22) PCT Filed: Oct. 20, 2023
(86) PCT No.: PCT/EP2023/079315

§ 371 Date: Mar. 11, 2025

(30) Foreign Application Priority Data
Dec. 9, 2022 (DE) 10 2022 213 386.2

(51) Int. Cl. G06T 5/60; G06T 5/80; G06T 7/80; G06V 10/32; G06V 10/82; G06V 20/56

(52) U.S. Cl. CPC G06T 5/60; G06T 5/80; G06T 7/80; G06V 10/32; G06V 10/82; G06V 20/56; G06T 2207/20081; G06T 2207/20084; G06T 2207/30252

(57) ABSTRACT

A method for processing image data for the application of a machine learning model. The method includes: ascertaining image data, wherein the image data result from image acquisition with a camera; transforming the image data into a sight ray representation; providing an input for the machine learning model based on the image data in the sight ray representation.

### FIELD

The present invention relates to a method for processing image data for the application of a machine learning model. The present invention also relates to a computer program and to a device for this purpose.

### BACKGROUND INFORMATION

Some conventional computer vision algorithms can be used to improve images from a camera recording, in particular for a vehicle. The adaptation of computer vision algorithms to different camera distortions is typically formulated as a domain adaptation problem. This involves ensuring the domain invariance using a special training procedure in which the same CNN is trained on images with different camera distortions so that the resulting weights can be generalized across domains.

X. Peng, Y. L. Murphey, S. Stent, Y. Li, and Z. Zhao, “Spatial focal loss for pedestrian detection in fisheye imagery,” 2019 IEEE Winter Conference on Applications of Computer Vision (WACV), pp. 561-569, 2019 describes special types of costs that reweight samples with different camera distortions to promote the learning of domain-invariant features.

### SUMMARY

The present invention includes a method, a computer program, and a device. Further features and details of the present invention will emerge from the disclosure herein. Features and details which are described in connection with the method according to the present invention will of course also apply in connection with the computer program according to the present invention, the device according to the present invention, and respectively vice versa, so that mutual reference is or can always be made with respect to the disclosure of the individual aspects of the present invention.

According to an example embodiment of the present invention, a method for processing, in particular preprocessing, image data for the application of a machine learning model, is provided, comprising the following steps, which are preferably carried out one after the other and/or repeatedly:
ascertaining image data, wherein the image data result from image acquisition with a camera, preferably of a vehicle,
transforming, preferably converting, the image data into a sight ray representation,
providing an input for the machine learning model based on the image data in the sight ray representation, preferably in order to use the machine learning model with the input, preferably in order to evaluate, for example classify and/or segment, the image data.

The input is based on a sight ray representation, and thus in particular on a camera-independent representation of the image data. This has the advantage that the machine learning model, preferably in the form of an artificial neural network, can be used independently of the specific camera type. The vehicle can be configured as a motor vehicle, for instance, preferably a passenger vehicle. The vehicle in particular comprises a driving function for autonomous driving and/or for assisting a driver of the vehicle. The driving function can be designed to control, for example steer and/or accelerate, the vehicle based on the image data and/or an output of the used machine learning model.

It is also possible that the image data in the sight ray representation are represented by image points, wherein providing the input can comprise the following step for further preprocessing:
providing a grid representation in which a grid comprises a plurality of grid cells, wherein the image points are assigned to the grid cells.

The grid density and the exact assignment can be hyperparameters of the method according to the present invention. In this context of machine learning, a hyperparameter is in particular a parameter the value of which is used to control the learning process. The geometric shape of the grid can be predefined and can correspond to a projection surface of the sight rays, for instance, preferably the image plane, of the sight ray representation.

The image points can be those points on the grid in which the sight rays are incident. In other words, the image points can each represent an intersection point with a sight ray of the sight ray representation. The image points can therefore also be referred to as ray intersection points.

The term “sight ray” is customary in the field for a depiction such as that described in Z. Zhang, “Camera Parameters (Intrinsic, Extrinsic),” pp. 81-85. Boston, MA: Springer US, 2014 or Ikeuchi, K. (eds) Computer Vision. Springer, Boston, MA. This representation essentially describes a point at which the light beam that has produced a point or pixel in the image data has hit a hypothetical plane (also referred to in the context of the present invention as a projection surface) on the optical path. This representation is therefore also referred to as a “sight ray representation”. The hypothetical plane is often also referred to as the “image plane”. It should be noted that, despite the term “plane”, any virtual surface, such as a sphere, can also be constructed as an image plane, and the sight ray representation of an image, i.e., the image data, can be calculated relative to that surface.

According to an example embodiment of the present invention, the image data can initially be available in an image representation, for example a pixel matrix representation. This can be the depiction of the image data as typically provided by the camera. The image data can then be transformed into the sight ray representation. In the next step, the sight ray representation can be converted into a representation that refers to a grid, preferably a two-dimensional (2D) grid. This can be referred to as providing the grid representation. This means that a grid, preferably a 2D grid, is specified on the image plane (or the projection surface onto which the sight rays have been projected), and each sight ray is assigned to a grid cell in that grid. The image points can therefore be those points on the grid in which the sight rays are incident onto the image plane or projection surface.

According to an example embodiment of the present invention, it is further optionally provided that the image points are assigned to the grid cells in different numbers, wherein providing the input comprises the following step for further preprocessing:
carrying out a normalization based on the grid representation, preferably by normalizing a distance between a cell center point of the respective grid cell and the respective image points assigned to the grid cell in the grid representation.

The grid representation can be converted into a convolution representation and/or normalized to a 2D grid consisting of fixed-length vectors. This can have the advantage that it can be processed using machine learning algorithms, in particular standard CNN approaches.

The advantage can also be achieved that the method according to the present invention makes it possible to convert the image data into a distortion-free representation, so that the machine learning model can be used as a generic algorithm, e.g. for identifying objects in the image data or for semantic segmentation of the image data. This enables the use of the method according to the present invention, for instance in machines such as vehicles or robots, to control the machine based on said object identification.

In the context of the present invention it can also be provided that the normalization calculates a feature map, wherein, for each of the grid cells, the feature map comprises a feature vector which is calculated from the image points of the respective grid cell. This makes it possible to carry out a series of tasks, such as semantic segmentation or object identification, on the basis of the feature map using the machine learning model. For example, labels can also be depicted on the grid representation in order to enable the training of the machine learning model.

It can also be possible that the normalization is based on an application of a neural network to the image points of the respective grid cell. Applying the neural network in the form of a CNN (convolutional neural network) makes it possible to maintain the feature map at the 2D grid level, for instance. This enables direct modeling of camera distortions. It can therefore also optionally be provided that the neural network comprises at least one convolutional layer.

According to an example embodiment of the present invention, it is also possible that the feature map includes a single feature vector, preferably with at least one channel, per grid cell. Applied to all grid cells, the result of this procedure can be a feature map having the same dimensions as the 2D grid already described above.

In the context of the present invention, it can preferably be provided that the machine learning model is used with the provided input, wherein a vehicle is controlled based on the application of the machine learning model, wherein the machine learning model is preferably trained using dropout, preferably a special form of dropout. A vehicle function, such as a driver assistance function and/or an autonomous driving function, can be provided, which evaluates an output of the used machine learning model to then control the vehicle based on it. A dropout in the first layer can moreover be used during training of the machine learning model in order to make the machine learning model robust to changes in the optical parameters.

According to an example embodiment of the present invention, the machine learning model, hereinafter also referred to in short as the model, can have been trained beforehand on image data from a camera of a specific type. Due to the advantageous transformation into the sight ray representation, the machine learning model trained in this way is nonetheless suitable for use with other types of cameras. When using the machine learning model, the type and/or imaging errors, such as distortions, of the camera can differ from that of a camera used to train the machine learning model. The model can thus preferably be trained such that is invariant to differences in the optical properties between cameras. The method according to the present invention can therefore preferably be used to apply models such as CNNs to camera distortions that were not yet foreseen during training.

According to an example embodiment of the present invention, directly modeling camera distortions also provides a number of advantages. First, explicitly modeling prior knowledge about the distortions can make the learning problem less difficult. There is no need for a neural network to learn the transformations between different distortions implicitly because they are explicitly modeled in the CNN structure. This can free up capacity in the model that can be used to learn features that are relevant to the task at hand. Explicitly training invariance to camera distortions also enables the use of different machine learning models, e.g. in the form of deep learning models, that have been trained for completely different camera distortions, in particular if the sensors of the two cameras are compatible. The machine learning model could also be used on fisheye cameras, for instance, even if the model was not trained on such camera distortions. This also means that the application of a trained machine learning model to a data set with a different camera distortion (e.g. oblique view images) does not require extensive labeling and retraining.

Another subject matter of the present invention is a computer program, in particular a computer program product, comprising instructions that, when the computer program is executed by a computer, prompt said computer program to carry out the method according to the present invention. The computer program according to the present invention has the same advantages as those described in detail with reference to a method according to the present invention.

The present invention also relates to a data processing device which is configured to carry out the method according to the present invention. The device can be a computer, for example, that executes the computer program according to the present invention. The computer can comprise at least one processor for executing the computer program. A non-volatile data memory can also be provided, in which the computer program can be stored and from which the computer program can be read by the processor for execution.

The present invention can also relate to a computer-readable storage medium which comprises the computer program according to the present invention. The storage medium is configured as a data memory such as a hard drive and/or a non-volatile memory and/or a memory card, for example. The storage medium can be integrated in the computer, for instance.

The method according to the present invention can moreover also be configured as a computer-implemented method.

Further advantages, features, and details of the present invention will emerge from the following description, in which embodiment examples of the present invention are described in detail with reference to the figures. The features herein can each be essential to the present invention individually or in any combination.

### BRIEF DESCRIPTION OF THE DRAWINGS

FIGS. 1A and 1B show an example visualization of the various optical parameters of cameras.

FIG. 2 shows a definition of a 2D grid on the image plane for converting sight rays into relative representations.

FIG. 3 shows an application of a CNN to the relative sight ray representation.

FIG. 4 shows an example implementation of the embodiment example according to FIG. 3, in which the CNN is a transformer network.

FIG. 5 shows embodiment examples of the present invention visualized in blocks.

FIG. 6 shows a schematic visualization of a method, a device, and a computer program according to embodiment examples of the present invention.

### DETAILED DESCRIPTION OF EXAMPLE EMBODIMENTS

In the following figures, the same reference signs are used for the same technical features even of different embodiment examples.

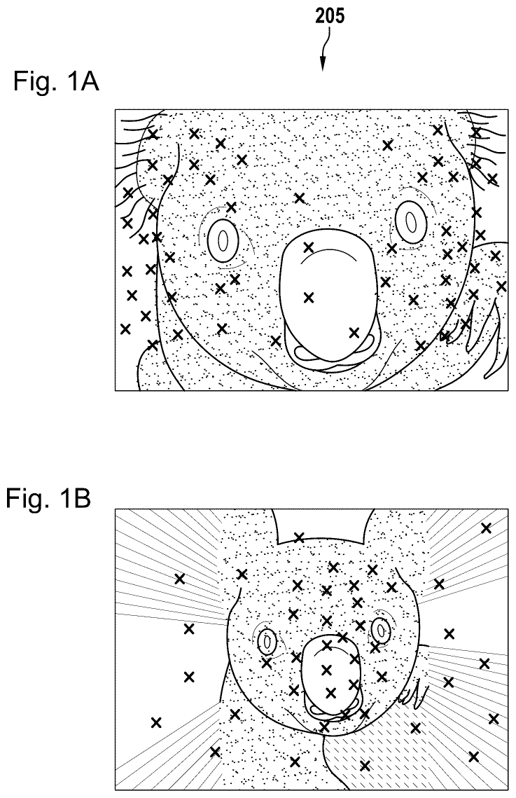

Since cameras typically record visual information using a method in which the individual sensors are arranged in a grid, the output of such cameras is a matrix of pixel values. FIGS. 1A and 1B show an example of such pixels. It is often useful to first convert this pixel matrix into a different representation as follows. The camera intrinsic parameters can be used to calculate the coordinates at which the light hits the image plane for each pixel (see for example Z. Zhang, “Camera Parameters (Intrinsic, Extrinsic),” pp. 81-85. Boston, MA: Springer US, 2014.). This representation essentially describes a point at which the light beam that has produced the pixel has hit a hypothetical plane on the optical path. This representation is therefore also referred to as a “sight ray representation”. It should be noted that this representation can always relate to a plane that is typically referred to as the “image plane”. It is, however, also possible to construct any virtual surface and calculate the sight ray representation of an image relative to that surface. To train camera-independent models, it can be useful to choose a virtual surface that can easily be generalized between different cameras, e.g. a sphere around the camera.

FIGS. 1A and 1B illustrate the various optical parameters of cameras. A barrel distortion is applied to the first image (FIG. 1A), as a result of which more pixels are mapped on the sides of the image than in the middle. The second image (FIG. 1B), on the other hand, is subjected to a distortion in which more pixels are mapped in the middle region and fewer at the edges.

Computer vision algorithms that use deep learning are highly successful in a variety of applications. They rely on a specific representation of the information acquired by a camera: a series of pixels that are arranged in a matrix structure with specific proximity relationships: An image is typically a H×W×C matrix with multiple values, wherein H and W are the height and width of the image and C is the number of channels, e.g. 3 for an RGB image. However, this representation is largely camera-dependent, because the optical parameters of the camera determine the pixel representation, e.g. of an object in the real world (see FIG. 1). Conventional machine learning models trained on such images can therefore only learn this camera-specific representation and have problems when this representation changes because a different camera is used-even if the recorded object is the same (see for example X. Peng, Y. L. Murphey, S. Stent, Y. Li, and Z. Zhao, “Spatial focal loss for pedestrian detection in fisheye imagery,” 2019 IEEE Winter Conference on Applications of Computer Vision (WACV), pp. 561-569, 2019).

Embodiment examples of the present invention, on the other hand, can overcome these disadvantages with the following steps:

The image can first be converted into a sight ray representation using conventional methods. The points can secondly then be converted into relative coordinates along a 2D grid. Thirdly, a fully convolutional network can be applied to this representation for each grid cell and, fourthly, a normal CNN can subsequently be applied to the resulting feature map to solve a specific task (e.g. semantic segmentation). Fifth, a dropout in the first layer can moreover be used during training in order to make the model robust to changes in the optical parameters. The steps of the method are described in the following in more detail.

First, the image representation, preferably pixel matrix representation, of an image can be converted into a sight ray representation. This can be done using conventional methods from the related art (see for example Z. Zhang, “Camera Parameters (Intrinsic, Extrinsic),” pp. 81-85. Boston, MA: Springer US, 2014. In: Ikeuchi, K. (eds) Computer Vision. Springer, Boston, MA.). This representation essentially consists of a set of points pi∈P, wherein pi=(xᵢ, yᵢ, rgbᵢ) and xᵢ, yᵢ, are coordinates on the image plane and rgbᵢ is the color information of the pixels (it should be noted that the same method can be used for every color space, not just RGB, and can be trivially extended for other modalities such as RGBD).

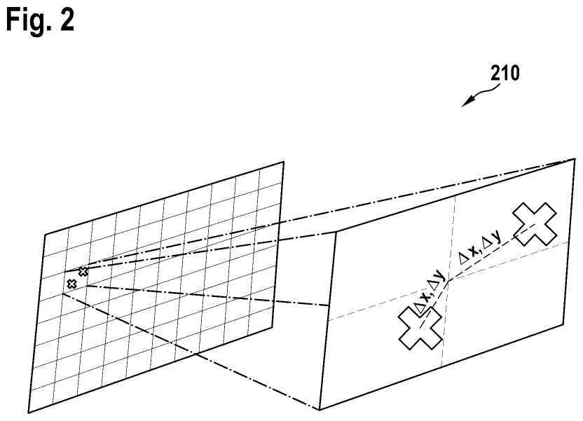

In the next step then, the sight ray representation can be converted into a representation that refers to a two-dimensional (2D) grid. This means that a 2D grid is specified on the image plane (or the plane onto which the sight rays have been projected), and each sight ray is assigned to a grid cell in that grid. This serves as preprocessing and only needs to be carried out once as shown in FIG. 2. In this context, it is also referred to as a grid representation. The relative sight ray representation therefore consists of points lᵢ∈L, wherein lᵢ=(Δxᵢ, Δyᵢ, rgbᵢ), wherein Δxᵢ, Δyᵢ, are coordinates relative to the nearest grid point. Essentially, these steps can be used to map the representation of the sight rays onto a 2D grid. However, this representation may not yet be able to be used directly by the machine learning model, because there are different number of mapped sight rays in each grid cell.

FIG. 2 visualizes the definitions of a 2D grid on the image plane for converting sight rays into relative representations. Both the grid density and the exact assignment method can be hyperparameters of a method according to embodiment examples of the present invention.

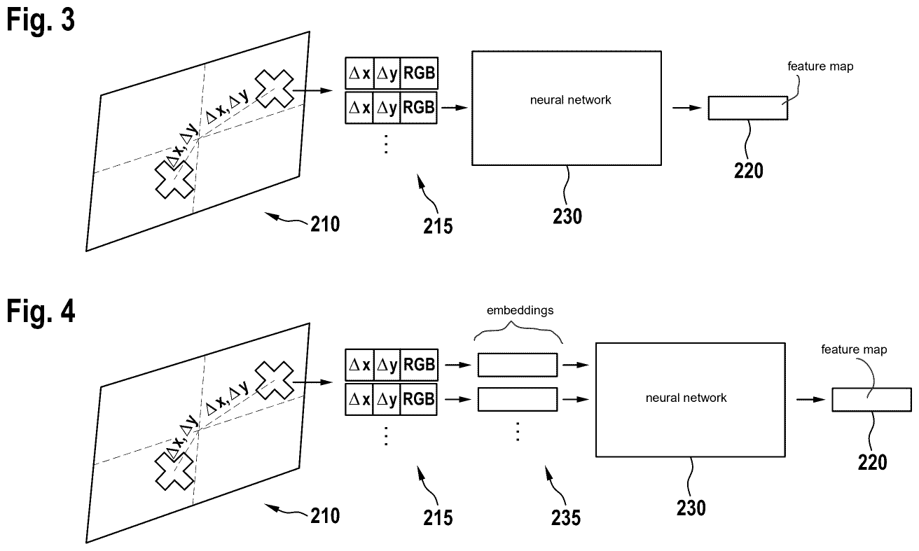

In a further step, the relative sight ray representation, preferably the grid representation, can be converted into a convolution representation. In other words, the relative sight ray representation can be normalized to a 2D grid consisting of fixed-length vectors. This can have the advantage that it can be processed using standard CNN approaches as shown in FIG. 3. For this purpose, an artificial neural network, such as a CNN, can be applied to one or more points lᵢ for each grid cell to calculate several features for that grid cell. This can involve one or more one-dimensional convolutional layers and global average pooling, for example. The crucial factor can be that the resulting feature map has to have a single feature vector (with one or more channels) per grid cell. Applied to all grid cells, the result of this procedure can be a feature map having the same dimensions as the 2D grid already described above. The CNN can be defined in a variety of ways, e.g. as a series of convolutions and poolings with a variable input size as in FIG. 3, or as a transformer network as used in A. Dosovitskiy, L. Beyer, A. Kolesnikov, D. Weissenborn, X. Zhai, T. Unterthiner, M. Dehghani, M. Minderer, G. Heigold, S. Gelly, J. Uszkoreit, and N. Houlsby, “An image is worth 16×16 words: Transformers for image recognition at scale,” ArXiv, vol. abs/2010.11929, 2020 and illustrated in FIG. 4.

FIG. 3 visualizes an application of a CNN to the relative sight ray representation. The CNN preferably works with a variable input size N_i×D, wherein Nᵢ is the number of sight rays assigned to the grid cell i and D is the input dimension (5 for 2D RGB). The output of this block can then be generated in a fully convolutional manner and have the form F, wherein 1×F is the selected feature dimension (this is a hyperparameter of the model, just as is the case with all of the other convolutional layers). FIG. 4 shows an alternative implementation of the embodiment example according to FIG. 3, in which the CNN is a transformer network.

Lastly, a standard CNN can be applied to the feature map output in the previous step in order to carry out a series of tasks such as semantic segmentation or object identification. The labels can preferably also be mapped to the above-described grid representation in order to enable training.

A particular advantage can be made possible by training the resulting model in such a way that it is robust to changes in the sight ray representation. This can be possible in particular by allowing the assignment method from P to L to be changed dynamically. A form of dropout can be included, for example, in which several lᵢ points from each grid cell are randomly hidden, which effectively results in less information being available to the grid cells. Since the CNN applied to the Lᵢ points are fully convolved and are therefore shared by all of the grid cells, this results in a distortion-independent information processing step that works for images from cameras with different optical properties.

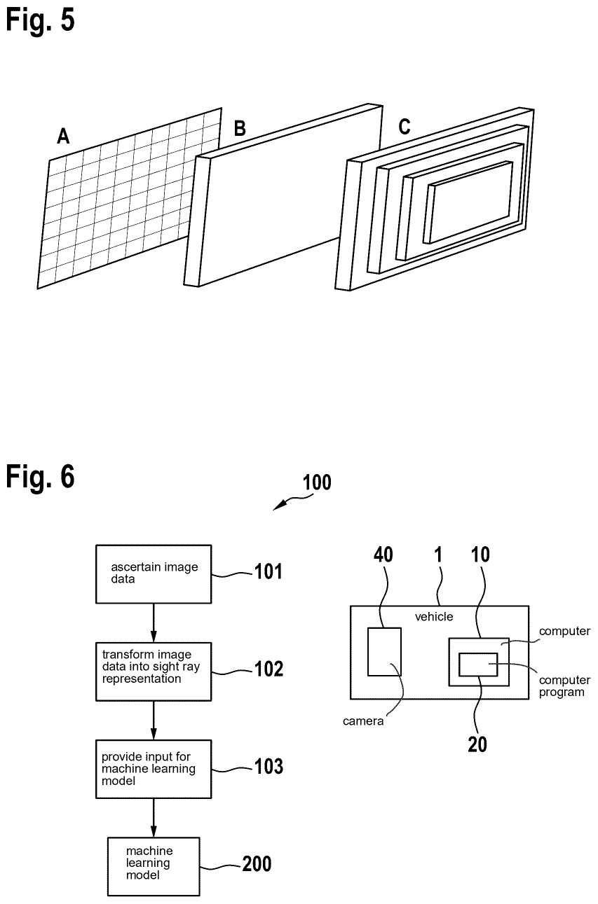

FIG. 5 visualizes embodiment examples of the present invention in blocks: creating a (relative) sight ray representation (A), applying a CNN to obtain a feature map on a 2D grid level (B), and applying a standard CNN to the resulting features (C).

FIG. 6 schematically shows the method as well as a device and a computer program 20 for execution on a computer 10 according to embodiment examples of the present invention. In a first method step 101, the method 100 for processing image data 205 for the application of a machine learning model 200 can comprise ascertaining 101 image data 205, wherein the image data 205 result from image acquisition with a camera 40. According to a second method step 102, the image data 205 can then be transformed into a sight ray representation. Subsequently, according to a third method step 103, an input for the machine learning model 200 can be provided based on the image data 205 in the sight ray representation. This provision can include a data transmission, for example, in which the image data-possibly after further preprocessing-is passed on to the machine learning model as the input.

FIG. 2 shows that the image data 205 can be represented in the sight ray representation by image points 215. Further preprocessing can also make it possible to provide the grid representation 210, in which the grid comprises a plurality of grid cells, wherein the image points 215 are assigned to the grid cells. The image points 215 can be assigned to the grid cells in different numbers. A normalization can then be provided, in which a distance between the respective cell center point and the respective image points 215 can be normalized in the grid representation, e.g. by a neural network 230, resulting in a feature map 220 (see FIG. 3).

The feature map 220 can advantageously comprise a single feature vector, preferably with at least one channel, per grid cell. FIG. 4 shows that a transformer 230 can also be used as a neural network 230 with a previous generation of “embeddings” 235 to generate the feature map 220.

As shown in FIG. 6, it can preferably be provided that the machine learning model 200 is used with the provided input, wherein a vehicle 1 is controlled based on the application of the machine learning model 200, wherein the machine learning model 200 is preferably trained using dropout, preferably a special form of dropout. A vehicle function, such as a driver assistance function and/or an autonomous driving function, can be provided, which evaluates an output of the used machine learning model 200 to then control the vehicle 1 based on it. A dropout in the first layer can moreover be used during training of the machine learning model in order to make the machine learning model robust to changes in the optical parameters.

The above explanation of the embodiments describes the present invention solely within the scope of examples. Of course, individual features of the embodiments can be freely combined with one another, if technically feasible, without leaving the scope of the present invention.

1-10. (canceled)

11. A method for processing image data for application of a machine learning model, comprising the following steps:
ascertaining image data, wherein the image data result from image acquisition with a camera;
transforming the image data into a sight ray representation; and
providing an input for the machine learning model based on the image data in the sight ray representation.

12. The method according to claim 11, wherein the image data in the sight ray representation are represented by image points, wherein the providing of the input includes the following step for further preprocessing:
providing a grid representation in which a grid includes a plurality of grid cells, wherein the image points are assigned to the grid cells.

13. The method according to claim 12, wherein the image points are assigned to the grid cells in different numbers, wherein the providing of the input includes the following step for further preprocessing:
carrying out a normalization based on the grid representation, by normalizing a distance between a cell center point of each respective grid cell and the image points assigned to the respective grid cell in the grid representation.

14. The method according to claim 13, wherein the normalization calculates a feature map, wherein, for each respective grid cell of the grid cells, the feature map includes a feature vector which is calculated from the image points of the respective grid cell.

15. The method according to claim 13, wherein the normalization is based on an application of a neural network to the image points of the respective grid cell.

16. The method according to claim 15, wherein the neural network includes at least one convolutional layer.

17. The method according to claim 14, wherein the feature map includes a single feature vector, with at least one channel per grid cell.

18. The method according to claim 11, wherein the machine learning model is used with the provided input, wherein a vehicle is controlled based on the application of the machine learning model, wherein the machine learning model is trained using dropout.

19. A non-transitory computer-readable medium on which is stored a computer program including instructions for processing image data for application of a machine learning model, the instructions, when execute by a computer, causing the computer to perform the following steps:
ascertaining image data, wherein the image data result from image acquisition with a camera;
transforming the image data into a sight ray representation; and
providing an input for the machine learning model based on the image data in the sight ray representation.

20. A device for data processing, the device configured to process image data for application of a machine learning model, the device configured to:
ascertain image data, wherein the image data result from image acquisition with a camera;
transform the image data into a sight ray representation; and
provide an input for the machine learning model based on the image data in the sight ray representation.
